(19) United States
(12) Patent Application Publication
(10) Pub. No.: US 2010/0269709 A1
(43) Pub. Date: Oct. 28, 2010

(54) Universal expandable splash guard for cookware

(76) Inventor: Yair I. Abed, San Diego, CA (US)

Correspondence Address: GARY L. EASTMAN, Gary L. Eastman, APLC, 401 W. "A" Street, Suite 1785, SAN DIEGO, CA, 92101, US

(21) Appl. No.: 12/381,376

(22) Filed: Mar. 10, 2009

Related U.S. Application Data
(60) Provisional application No. 61/069,028, filed on Mar. 10, 2008.

(51) Int. Cl. A47J 36/00

(52) U.S. Cl. 99/340

(57) ABSTRACT

A Universal Expandable Splash Guard for Cookware of the present invention includes a substantially planar, yet flexible panel that is positionable around the rim of a pot or pan and removably attachable thereto. The panel, in a preferred embodiment, is made of a heat-tolerant durable yet flexible material, such as silicone, that may be formed with a receiver slot or clips to receive the upper rim of a pot or pan. Alternatively, the panel may be made from an aluminum foil. The Universal Expandable Splash Guard for Cookware can then be attached to the cookware for the duration of the cooking process, and then easily removed for cleaning and storage. An alternative embodiment of the Universal Expandable Splash Guard for Cookware includes a cylindrical tube positioned atop a circular planar panel that is formed with a hole the same size of the interior diameter of the tube. This embodiment is positionable over the top of a stock pot or sauce pan to extent the rim of the pan to prevent the contents of the cookware from splashing out while cooking.

### RELATED APPLICATIONS

The present Utility patent application claims the benefit of priority to U.S. Provisional Patent Application Ser. No. 61/069,028 entitled “Universal Expandable Splash Guard for Cookware” that was filed on Mar. 10, 2008, by the same inventor, and currently co-pending.

### FIELD OF THE INVENTION

The present invention relates generally to cookware. The present invention is more particularly, though not exclusively, useful as a cookware accessory that minimizes the mess resulting from cooking sauces.

### BACKGROUND OF THE INVENTION

Cookware of all types has been in use for centuries. Over the years, the materials used for cookware have changed from earthen pots, to cast iron cauldrons, and eventually to today's state of the art cookware incorporating non-stick and bi-metal cooking surfaces. Despite the extraordinary technical gains made in the construction of the cookware, there have been few improvements in the safety of the cookware. For instance, the handles of the modern cookware are more heat-resistant that early handles. Another safety improvement the lids of the cookware may fit a bit more snug than those earlier lids, but when cooking with the lids off, such as needed when simmering sauces or frying with oil, the contents readily splash out of the cookware.

The splashing out of contents of the cookware presents a very difficult challenge to cookware manufactures. Specifically, in order to effectively cook certain foods, it is necessary for the cookware to breathe. Cooking sauces is a perfect example of such a food that requires access to air in order to properly simmer and cook. Unfortunately, most saucepans used for cooking such sauces have sealed lids that cannot be used or the sauces will not cook properly. Thus the only solution is to cook with no lid, resulting in the bubbling and splattering of the sauces out of the cookware and onto the cooking surface, wall, counter, and people. This splattering poses a significant safety hazard when realizing that this splattering is due to the boiling of the sauces, oil, or the like, that will burn or stain. In the most severe cases, these splattering materials may leave the cooking top to burn the cook, or passers by, including children.

In light of the above, it would be advantageous to provide a cookware accessory that minimizes the spattering of liquids, such as grease, water, or oil, from the cookware to leave a mess on the cooking top. It would also be advantageous to provide a cookware accessory that is easily attachable to cookware during the cooking process, and does not inhibit the cook's use of the cookware to stir, add ingredients, taste or observe the food being cooked. It would also be advantageous to provide a reusable cookware accessory that is easy to use, easy to clean, and relatively cost effective. It would also be advantageous to provide a solution to the cooking challenges by providing an add-on accessory to ordinary cookware which would minimize the splattering messes which result from cooking sauces and other liquid-based recipes.

### SUMMARY OF THE INVENTION

The Universal Expandable Splash Guard for Cookware of the present invention includes a substantially planar, yet flexible panel that is positionable around the rim of a pot or pan and removably attachable thereto. The panel, in a preferred embodiment, is made of a heat-tolerant durable yet flexible material, such as silicone, that may be formed with a receiver slot or clips to receive the upper rim of a pot or pan. Alternatively, the panel may be made from an aluminum foil. The Universal Expandable Splash Guard for Cookware can then be attached to the cookware for the duration of the cooking process, and then easily removed for cleaning and storage.

An alternative embodiment of the Universal Expandable Splash Guard for Cookware includes a cylindrical tube positioned atop a circular planar panel that is formed with a hole the same size of the interior diameter of the tube. This embodiment is positionable over the top of a stock pot or sauce pan to extent the rim of the pan to prevent the contents of the cookware from splashing out while cooking.

### BRIEF DESCRIPTION OF THE DRAWINGS

The aforementioned and other advantages of the Universal Expandable Splash Guard for Cookware of the present invention will become more apparent to those skilled in the art upon making a thorough review and study of the following detailed description of the invention when reviewed in conjunction with the drawings in which like references numerals refer to like parts, and wherein:

FIG. 1 is a prior art sauce pan is shown with the sauce generating spattering messes from boiling

FIG. 2 is a Universal Expandable Splash Guard for Cookware of the present invention used in conjunction with a pan, such as a saucepan, and includes a splashguard, and a means for attaching the splashguard to the pan;

FIG. 3 is a cross-sectional view of a preferred embodiment of the universal expandable splash guard of the present invention showing a panel having an integral rim-engaging channel along its lower edge;

FIG. 4 is a cross-sectional view of an alternative preferred embodiment of the universal expandable splash guard of the present invention showing a panel formed with a rim-engaging channel;

FIG. 5 is a cross-sectional view of the universal expandable splash guard of FIG. 3 as shown in position over the rim of a pot, and with the rim-engaging channel deformed to grip the rim and secure the splash guard in place;

FIG. 6 is a cross-sectional view of the universal expandable splash guard of FIG. 4 as shown in position over the rim of a pot, and with the rim-engaging channel deformed to grip the rim and secure the splash guard in place;

FIG. 7 is a plan view of the universal expandable splash guard the present invention shown in FIG. 3, formed with a plurality of perforations positioned along the length of the panel to accommodate customizing the splash guard for particular sized pots, and having a tab to secure the upper edge of guard in place around a pot;

FIG. 8 is a perspective view of the universal expandable splash guard the present invention as configured for placement over the rim of a pot with an overlapping flap to provide a continuous barrier to splashes exiting the pot during the cooking process;

FIG. 9 is a plan view of an alternative embodiment of the universal expandable splash guard the present invention showing a panel formed with a number of rim-engaging flap grips that may be bent away from the panel to capture the rim of the pot and secure the splash guard in place;

FIG. 10 is a cross-sectional view of the universal expandable splash guard the present invention shown in FIG. 9, with the rim-engaging flap grips being formed to capture the rim of the pot to secure the splash guard in place;

FIG. 11 is a perspective view of an alternative embodiment of the universal expandable splash guard the present invention as shown installed on a pot and secured in place with spaced apart rim clips, and showing the universal nature of the splash guard with a variable diameter and height;

FIG. 12 is a perspective view of the universal expandable splash guard the present invention shown in FIG. 11, in a rolled configuration such as when sold, and having a panel and a base piping that corresponds to the rim clips;

FIG. 13 is a perspective view of an embodiment of the rim clips of FIG. 11, showing a pair of channels sized to closely receive the base piping on the upper surface, and the rim of the pot on the lower surface;

FIG. 14 is cross-sectional view of the rim clip of FIG. 11 as used to fasten the splash guard of FIG. 12 to a pot;

FIG. 15 is a perspective view of an alternative embodiment of the rim clips of FIG. 11, showing a pair of channels sized to closely receive the base piping on the upper surface, and the rim of the pot on the lower surface;

FIG. 16 is a cross-sectional view of the rim clip of FIG. 15 as used to fasten the splash guard of FIG. 12 to a pot;

FIG. 17 is a perspective view of an alternative embodiment of the universal expandable splash guard the present invention having a fixed diameter tube and a substantially planar base ring sized to be placed flat on the rim of a pot;

FIG. 18 is a bottom plan view of the universal expandable splash guard the present invention of FIG. 17, showing a plurality of positioning rings of various sizes intended to maintain the position of the splash guard on the pot during use;

FIG. 19 is a cross-sectional view of an alternative embodiment of the universal expandable splash guard the present invention showing a panel having a deformable “C” shaped receiver channel sized to closely receive the rim of a pot to secure the splash guard on the pot;

FIG. 20 is a cross-sectional view of the universal expandable splash guard the present invention of FIG. 19 in position on the rim of a pot;

FIG. 21 is a cross-sectional view of an alternative embodiment of the universal expandable splash guard the present invention having an inverted “L” shaped receiver channel that is designed to accommodate pots having a variety of rim cross-sections, including a straight cross-section shown in this Figure;

FIG. 22 is a cross-sectional view of the universal expandable splash guard the present invention of FIG. 21, shown as installed on a pot having a tubular rim; and

FIG. 23 is a cross-sectional view of the universal expandable splash guard the present invention of FIG. 21, positioned above and ready to be attached to a pot having an inverted “L” shaped rim.

### DETAILED DESCRIPTION OF A PREFERRED EMBODIMENT

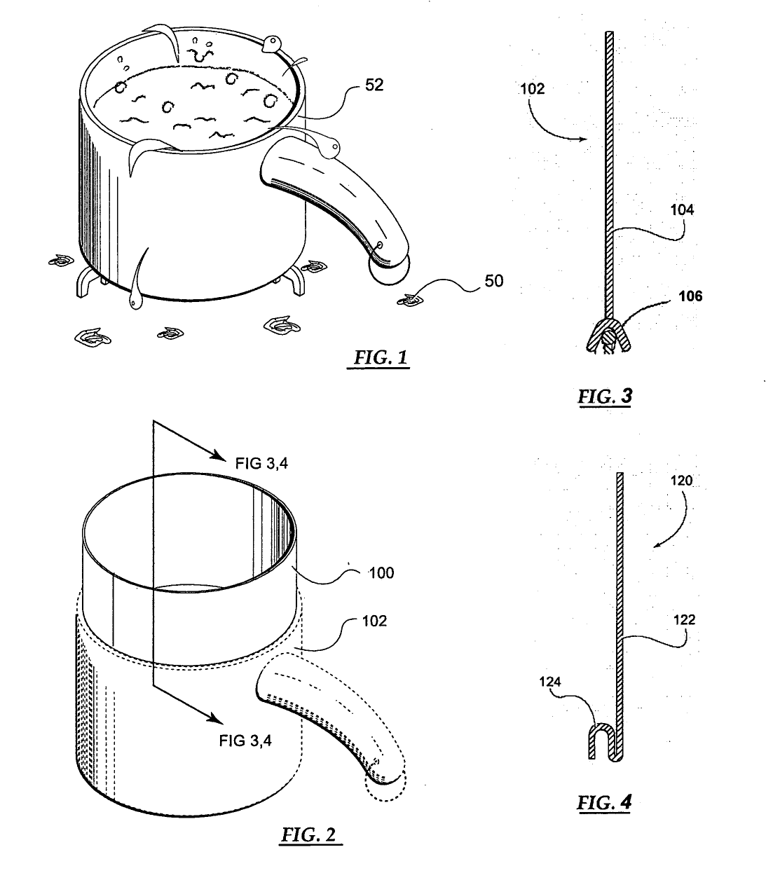

Referring to FIG. 1, a prior art sauce pan 52 is shown with the sauce generating spattering messes 50 from boiling. Typically, a sauce pan 52 is not tall enough to avoid the splattering of cooking sauces unless a lid is used. However, using a lid prevents the proper cooking and open-air simmering of many food recipes, and precludes the periodic tending and the addition of spices. Unfortunately, the splattering sauces 50, once dry, can present a very difficult cleaning challenge.

Referring now to FIG. 2, the Universal Expandable Splash Guard for Cookware of the present invention is shown and generally designated 100. Splash guard 100 is to be used in conjunction with a pan, such as a saucepan 102 shown in FIG. 2, and as will be discussed in greater detail below, includes a means for attaching the splashguard to the pan.

FIG. 3 is a cross-sectional view of a preferred embodiment of the universal expandable splash guard of the present invention 100 showing a panel 104 having an integral rim-engaging channel 106 along its lower edge. The rim-engaging channel 106 is sufficiently malleable to engage the upper rim of a pan to secure the panel in place for use.

Similarly, FIG. 4 is a cross-sectional view of an alternative preferred embodiment of the universal expandable splash guard of the present invention generally designated 120 and having a panel 122 formed with a rim-engaging channel 124 formed from the same material that the splashguard panel 122 is made from, in a formed continuous material sheet.

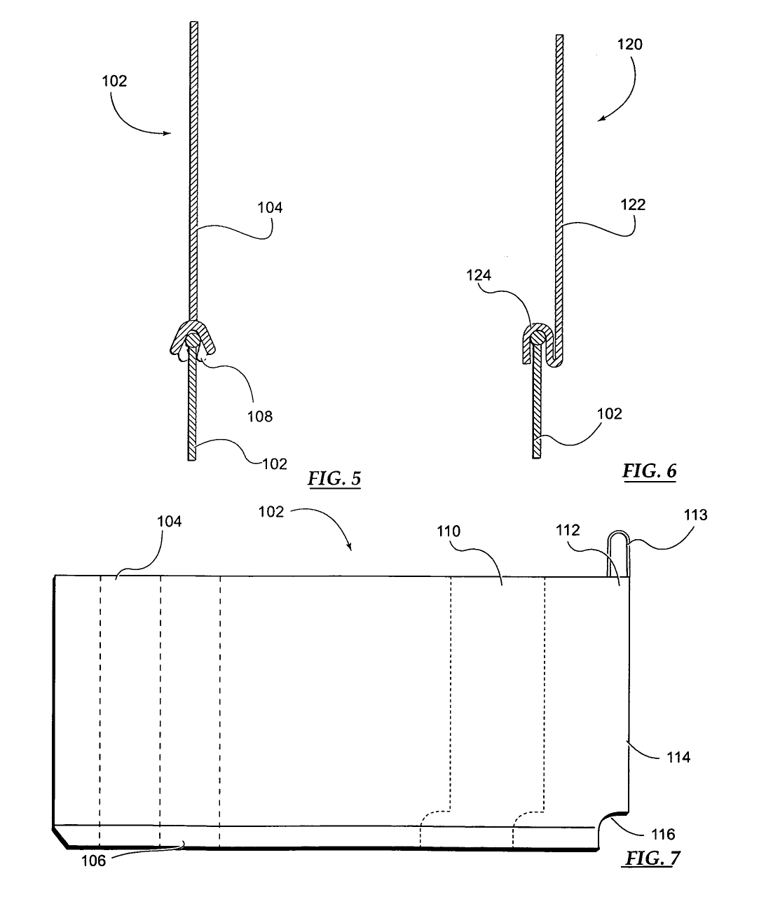

Referring now to FIG. 5, a cross-sectional view of the universal expandable splash guard 100 of FIG. 3 is shown in position over the rim of a pot 102. The rim-engaging channel 106 is shown in a first, open, configuration to receive the rim of pot 102. Once in position, rim-engaging channel 106 may be deformed into position 108 (shown in dashed lines) to secure splash guard 100 in place over the rim of pot 102.

Referring now to FIG. 6, a cross-sectional view of the universal expandable splash guard 120 of FIG. 4 is shown in position over the rim of a pot 102. The panel 122 with integral rim-engaging channel 124 is shown in an open configuration to receive the rim of pot 102. Once in position, rim-engaging channel 124 may be deformed to secure splash guard 120 in place over the rim of pot 102.

FIG. 7 is a plan view of the universal expandable splash guard the present invention 100 shown in FIG. 3. In this embodiment, panel 104 of splash guard 100 is shown to be formed with a plurality of perforations positioned along the length of the panel 104 to facilitate customizing the splash guard 100 for particular sized pots. More specifically, by tearing or cutting panel 104 along the dashed-line perforations, sections of the panel 104 may be removed, such as sections 110 and 112. This shortens the length of panel 104 to accommodate pots 102 having different diameters.

Also from FIG. 7, it can be seen that panel 100 may be equipped with a tab 113 that may be bent over where it joins panel 104 to secure the upper edge of panel 104 to itself once positioned around a pot 102. Also, panel 104 may be formed with a cutout 116 sized to provide clearance from the end of rim-engaging channel 106 when in position around the rim of pot 102.

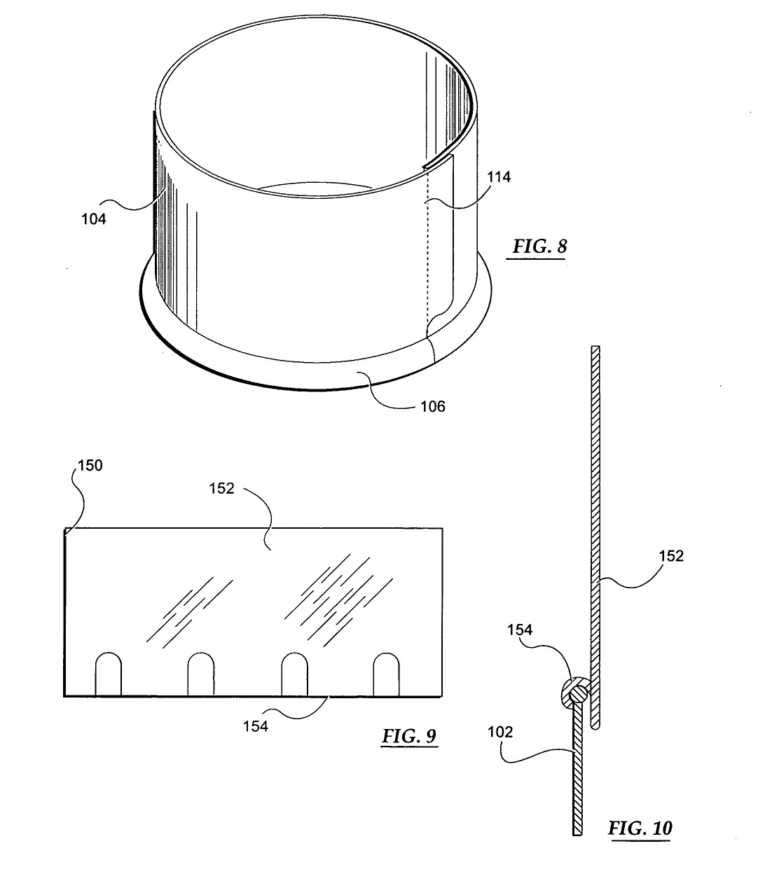

Referring now to FIG. 8, a perspective view of the universal expandable splash guard the present invention 100 is shown as configured for placement over the rim of a pot (not shown this Figure) with an overlapping flap 114 to provide a continuous barrier to splashes exiting the pot during the cooking process. Once in position, rim-engaging channel 106 may be deformed to grip the rim of pot 102 to secure splash guard 100 in place. In a preferred embodiment, the splash guard may be formed with a pre-formed tab on the upper surface of panel 104 to maintain in a closed position thereby preventing any gaping between the overlapping portions of panel 104.

FIG. 9 is a plan view of another alternative embodiment of the universal expandable splash guard the present invention generally designated 150 and having a panel 152 formed with a number of rim-engaging flap grips 154 that may be bent away from the panel 152 to capture the rim of a pot and secure the splash guard 150 in place. In this embodiment, rim-engaging flap grips 154 are spaced-apart along the length of panel 152, and may be bent away from panel 152.

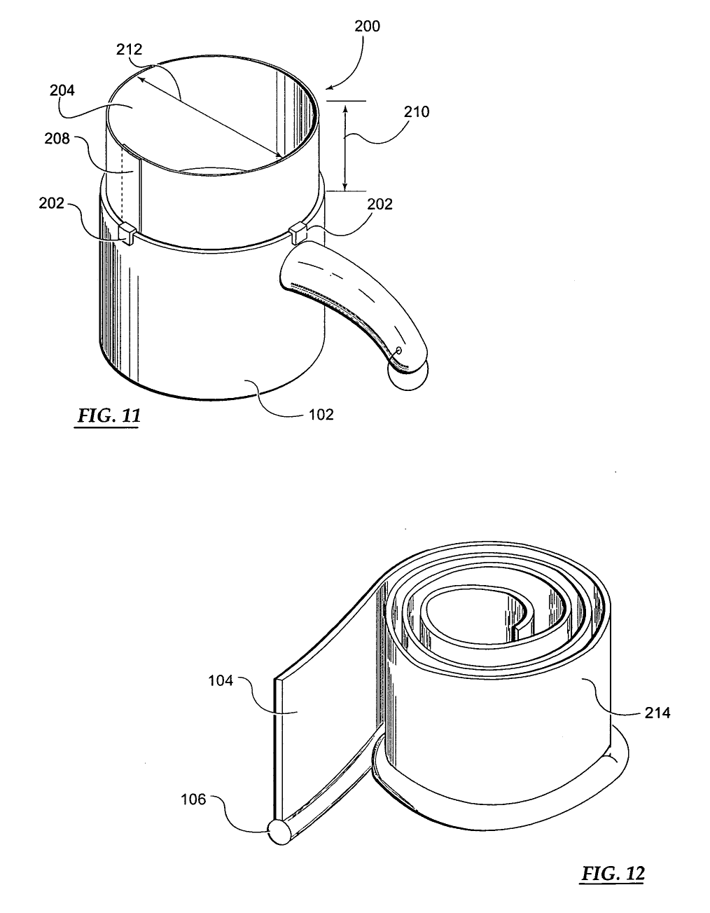

Referring to FIG. 10, a cross-sectional view of the universal expandable splash guard 150 of FIG. 9 is shown. In this Figure, panel 152 is formed with the rim-engaging flap grips 154, and as shown, these flap grips 154 may be deformed to capture the rim of the pot 102 to secure the splash guard 150 in place. The flap grips 154 can be bent inward or outward to capture the upper rim of a saucepan 102.

The universal expandable splash guard for cookware of the present invention as shown in FIGS. 2-10 are, in a preferred embodiment, made from aluminum foil. It is to be appreciated, however, that other materials may be used without departing from the present invention.

Referring now to FIG. 11, a perspective view of an alternative embodiment of the universal expandable splash guard the present invention is shown and generally designated 200. Splash guard 200 includes a number of saucepan rim clips 202 which are formed to snugly receive the rim of the pan 102. A panel 204 is formed with base piping (not shown this Figure) that is captured by rim clips 202 to secure the splash panel in place around the rim of the pan. As shown, this embodiment may be sized to fit pots 102 having different diameters 212 simply by overlapping the ends of the panel as shown by overlap 208. Also, in a preferred embodiment, panel 204 may have a height 210 of between 2 and 4 inches, for example.

As shown, splash guard 200 may be installed on virtually any pot 102 and secured in place with spaced apart rim clips 202. Because the length of panel 204 may be sized to virtually any length, the universal nature of the splash guard 200 with a variable diameter and height can be easily appreciated. Additional rim clips 202 may be added as needed to provide sufficient support to panel 204.

FIG. 12 is a perspective view of the universal expandable splash guard 200 shown in FIG. 11. From this Figure, panel 214 is shown to be formed with a base piping 215 that corresponds to, and is received closely within the rim clips 202.

From FIG. 12, it is to be appreciated that the present invention may be provided and sold in a package which contains several splash panels 104 in a flat configuration, and sold in an assortment of sizes. For instance, three sizes of splash panels may be provided, suitable for standard pans having diameters ranging from 6-8 inches, 8-10 inches, and 10-14 inches. Also, in this embodiment, the panels with the appropriate length may be selected, bent from its flat configuration to a round configuration to match the rim of the pan, and then attached to the rim with the grip channels, grip flaps, or with the clips as disclosed herein.

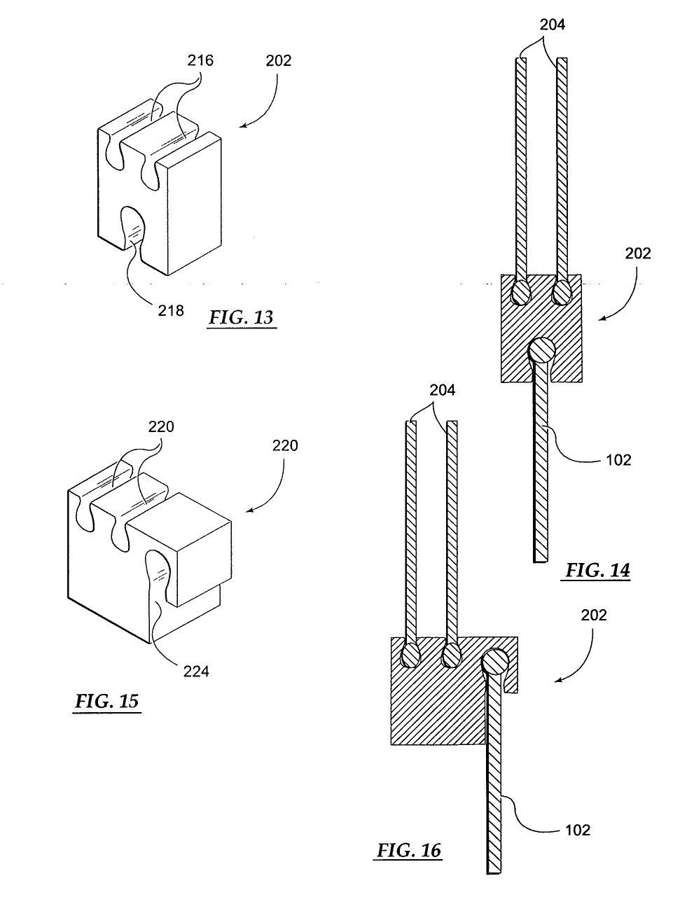

FIG. 13 is a perspective view of a preferred embodiment of the rim clips 202 of FIG. 11, showing a pair of piping-receiving slots 216 sized to closely receive the base piping 215 on the upper surface, and a pan rim receiver slot 218 on the lower surface. As shown in FIG. 14, the installation of the clips 202 over the upper rim of the pot 102 provides a means for the attachment of the splash panel 204 to pot 102.

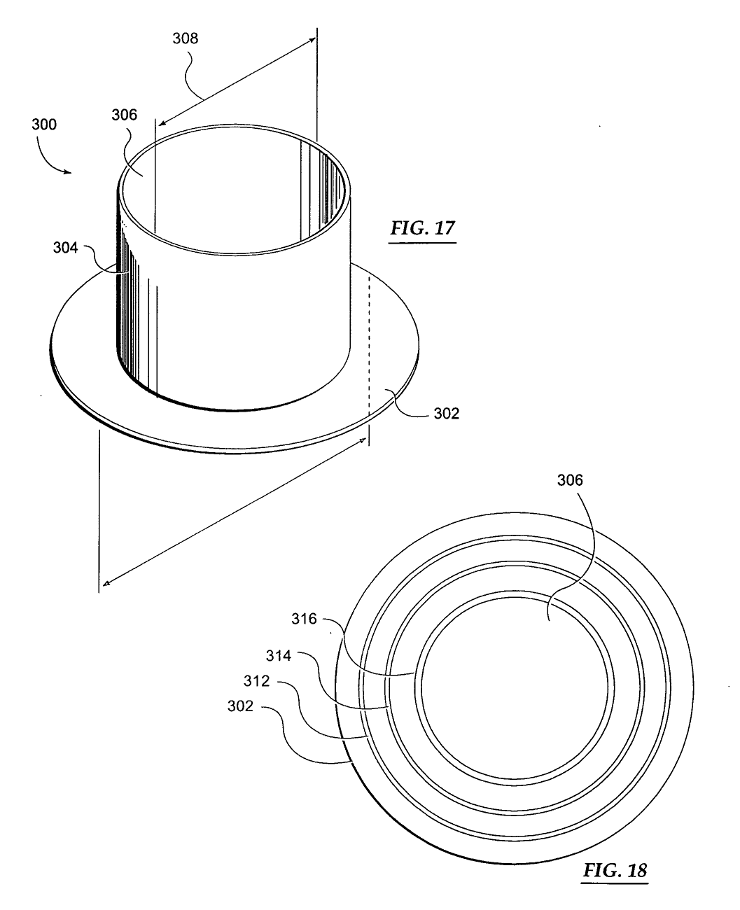

Referring now to FIG. 15, a perspective view of an alternative embodiment of the rim clips is shown and generally designated 220. Rim clip 220 includes a pair of piping-receiving slots 222 sized to closely receive the base piping 215 on the upper surface, and a pan rim receiver slot 224 on the lower surface. As shown in FIG. 16, the installation of the clips 220 over the upper rim of the pot 102 provides a means for the attachment of the splash panel 204 to pot 102.

The rim clip 220 of FIG. 15 has a different positioning of the piping receiving slots and pan rim receiver than rim clip 202 in order to position the splash panel 204 lower and on the inside or outside edge of the pan as shown in FIG. 16. While not shown in the Figures, it is to be appreciated that a clip having a single piping slot may be provided, and would be used by abutting the ends of the splash panel together to make a continuous panel around the rim of the pan.

In a preferred embodiment, the splash panel of FIGS. 11-16 is made of an easily washable material, such as Teflon, polypropylene, food-grade FDA approved silicone, or other easily washable material which is heat resistant. Other materials may be used, such as metal, plastic, or foil. In a preferred embodiment, the present invention may be disposable, such as when made from tin foil. Alternatively, the device may be made from a reusable material which, if heat and stain resistant, can provide years of use.

Referring now to FIG. 17, a perspective view of an alternative embodiment of the universal expandable splash guard the present invention is shown and generally designated 300. Splash guard 300 includes a fixed diameter tube 304 and a substantially planar base ring 302 sized to be placed flat on the rim of a pot (not shown this Figure). Tube 304 is formed to have a fixed diameter 308 to define an opening 306 through which a sauce or food may be tended to during the cooking process. It can be appreciated that diameter 308 may vary depending on the desired size of the opening. Base ring 302 has a diameter 310 that can be determined by the size pot to be accommodated by splash guard 300.

FIG. 18 is a bottom plan view of the universal expandable splash guard the present invention of FIG. 17, and shows base ring 302 formed with a plurality of positioning rings 312, 314, and 316 of various sizes. By placement of splash guard 300 over a pot (not shown this Figure), the rim of the pot will rest between rings 312, 314, or 316 to maintain the position of the splash guard on the pot during use.

Splash guard 300 is made from a substantially rigid material that maintains its shape during the cooking process. This may be made from known heat-tolerant polymers, and may in some embodiments, be made from polyethylene, polypropylene, metal, tin, aluminum, or other materials known in the art. These materials provide for a long product life, and also provide a splash guard that is easy to use and may be cleaned by simply placing the guard 300 in the dishwasher.

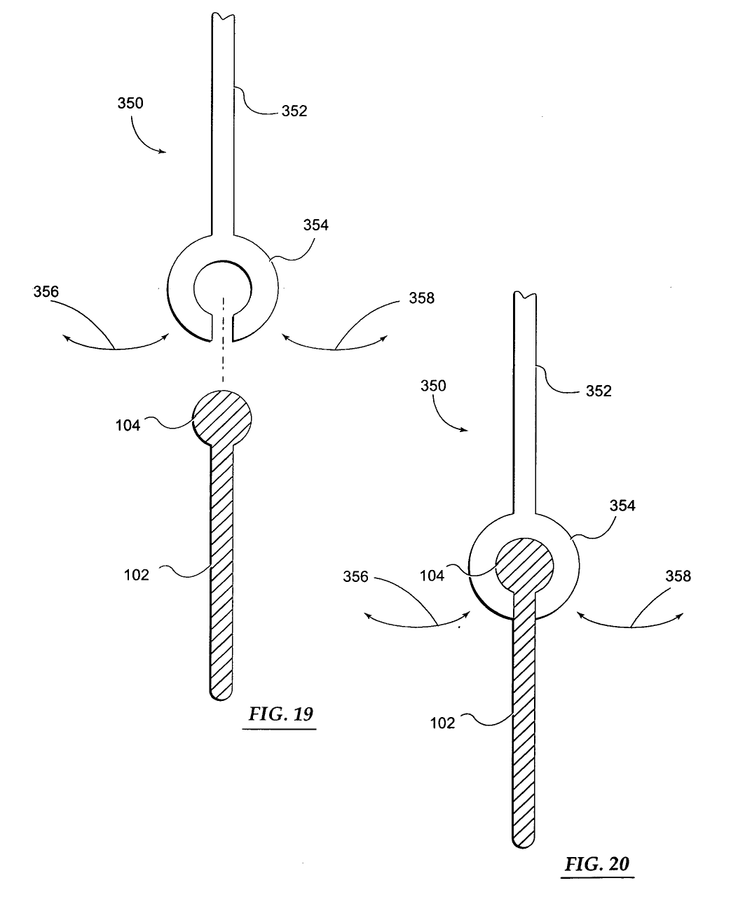

Referring now to FIG. 19, a cross-sectional view of yet another alternative embodiment of the universal expandable splash guard the present invention is shown and generally designated 350. Splash guard 350 includes a panel 352 having-a deformable “C” shaped receiver channel 354 sized to closely receive the rim 104 of a pot 102 to secure the splash guard on the pot. As shown in this Figure, “C” shaped receiver channel 354 may be deformed in directions 356 and 358 to receive rim 104 of pot 102. FIG. 20 shows splash guard 350 in position on the rim of a pot after the “C” shaped receiver channel 354 closes onto rim 104.

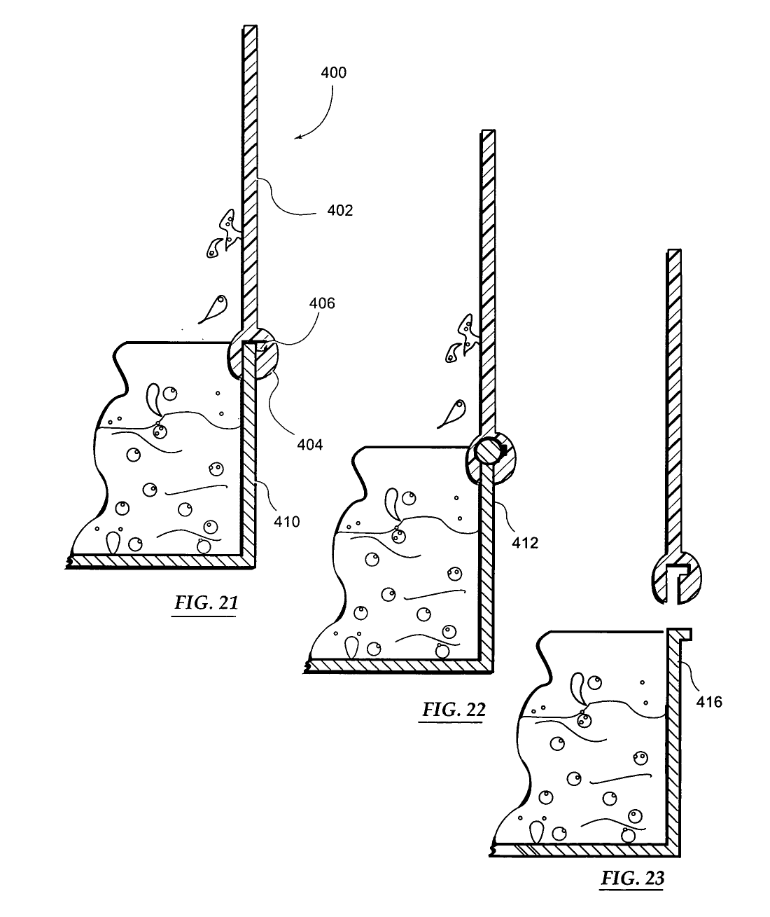

Referring to FIG. 21, a cross-sectional view of an alternative embodiment of the universal expandable splash guard the present invention is shown and generally designated 400. Splash guard 400 includes a panel 402 that is formed with an integral piping 404 that is deformable and formed with an inverted “L” shaped receiver channel 406 that is designed to accommodate pots having a variety of rim cross-sections. For instance, in FIG. 21, pot 410 has a straight cross-section that is received within receiver channel 406. Another example is shown in FIG. 22 in which splash guard 400 is shown installed on a pot 412 having a tubular rim. Yet another example is shown in FIG. 23 in which splash guard 400 is shown to be positioned above and ready to be attached to a pot 416 having an inverted “L” shaped rim.

The expandable splash guard the present invention as described herein includes a variety of embodiments, made from a variety of materials. While what has been disclosed herein are exemplary of preferred embodiments, it is to be appreciated that the embodiments set forth herein may be made from virtually any material known in the art that is capable of achieving the splash-inhibiting features of the present invention.

While the Universal Expandable Splash Guard for Cookware of the present invention as herein shown and disclosed in detail is fully capable of obtaining the objects and providing the advantages herein before stated, it is to be understood that it is merely illustrative of preferred and alternative embodiments of the invention and that no limitations are intended to the details of construction or design herein shown other than as described in the appended claims.

I claim:

1. A splash guard for cookware having a rim, said splash guard comprising:
a substantially planar panel having a rectangular shape with two opposite long sides; and
a means for securing said splash guard to said cookware.

2. The splash guard of claim 1, wherein said means for securing said splash guard to said cookware further comprises a clip.

3. The splash guard of claim 1, wherein said means for securing said splash guard to said cookware further comprises said panel formed with a plurality of deformable tabs formable to capture said rim of said cookware.

4. The splash guard of claim 1, wherein said means for securing said splash guard to said cookware further comprises:
said panel formed with piping along one of said opposite long sides; and
a plurality of rim clips, said clips are formed with a piping-receiving channel to receive said piping; and a rim-receiving channel to receive the rim of the pan.

5. The splash guard of claim 1, wherein said means for securing said splash guard to said cookware further comprises a rim receiver formed along one of said long sides, said rim receiver sized to receive said rim of said cookware and extend upwards therefrom.

6. The splash guard of claim 5, wherein said rim receiver is formed from said panel.

7. The splash guard of claim 5, wherein said rim receiver is integral to said panel.

8. The splash guard of claim 1, wherein said panel is formed with an overlap tab.

9. A splash guard for cookware having a rim, said splash guard comprising:
a panel having a rectangular shape with two opposite long sides; and
said panel formed with a deformable “C” shaped receiver channel along one of said opposite long sides, said channel sized to closely receive the rim of a pot to secure the splash guard on the pot.

10. A splash guard for cookware having a rim, said splash guard comprising:
a panel having a substantially rectangular shape with two opposite long sides; and
a plurality of rim-engaging flap grips formed from said panel and having a first configuration wherein said flap grips are co-planar with said panel, and a second configuration wherein a portion of said flap grips are formed to capture the rim of a pot.

11. A splash guard for cookware having a rim, said splash guard comprising:
a panel having a substantially rectangular shape with two opposite long sides; and
piping along one of said long sides, said piping formed with a receiver channel having an inverted “L” cross-section.

12. A splash guard for cookware having a rim, said splash guard comprising:
a fixed diameter tube having a bottom edge; and
a substantially planar base ring extending outwards from said bottom edge and sized to be placed flat on the rim of a pot.

13. The splash guard of claim 12, further comprising said base ring being formed with one or more concentric positioning rings.
